(19) United States
(12) Patent Application Publication
(10) Pub. No.: US 2026/0238416 A1
(43) Pub. Date: Aug. 13, 2026

(54) METHODS AND APPARATUS OF PTRS TRANSMISSION IN SIMULTANEOUS MULTI-PANEL TRANSMISSION

(71) Applicant: Lenovo (Beijing) Limited, Beijing (CN)

(72) Inventors: Lingling Xiao, Beijing (CN); Bingchao Liu, Beijing (CN); Chenxi Zhu, Fairfax, VA (US); Yi Zhang, Beijing (CN)

(73) Assignee: Lenovo (Beijing) Limited, Beijing (CN)

(21) Appl. No.: 19/470,758

(22) PCT Filed: Sep. 28, 2023
(86) PCT No.: PCT/CN2023/122585

§ 371 Date: Sep. 29, 2025

(51) Int. Cl. H04L 5/00; H04L 27/26

(52) U.S. Cl. CPC H04L 5/0044; H04L 27/261

(57) ABSTRACT

Various aspects of the present disclosure relate to methods and apparatus of Phase Tracking Reference Signal (PTRS) transmission in simultaneous multi-panel transmission. The apparatus includes a user equipment (UE) for wireless communication, comprising: at least one memory; and at least one processor coupled with the at least one memory and configured to cause the UE to: receive an indication for an uplink transmission that comprises at least one Physical Uplink Shared Channel (PUSCH) transmission associated with different Sounding Reference Signal (SRS) resource sets simultaneously; and determine parameters of PTRS transmission for each of the at least one PUSCH transmission.

### TECHNICAL FIELD

The present disclosure relates to wireless communications, and more specifically to methods and apparatus of Phase Tracking Reference Signal (PTRS) transmission in simultaneous multi-panel transmission.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The following abbreviations and acronyms are herewith defined, at least some of which are referred to within the specification: Third Generation Partnership Project (3GPP), New Radio (NR), Long Term Evolution (LTE), LTE Advanced (LTE-A), Orthogonal Frequency Division Multiplexing (OFDM), Downlink (DL), Uplink (UL), User Equipment (UE), Network Equipment (NE), Receive or Receiver (RX, or Rx), Transmit or Transmitter (TX, or Tx), Physical Downlink Control Channel (PDCCH), Physical Downlink Shared Channel (PDSCH), Physical Uplink Shared Channel (PUSCH), Bandwidth Part (BWP), Configured Grant (CG), Device to Device (D2D), Downlink Control Information (DCI), Demodulation Reference Signal (DMRS, or DM-RS), Frequency Division Multiple Access (FDMA), Internet of Things (IoT), Machine Type Communication (MTC), Non-Access Stratum (NAS), Protocol Data Unit (PDU), Phase-shift keying (PSK), Quadrature amplitude modulation (QAM), Radio Access Network (RAN), Resource Element (RE), Radio Resource Control (RRC), Reference Signal (RS), Single Frequency Network (SFN), Sounding Reference Signal (SRS), Vehicle-to-Everything (V2X), Amplitude Modulation (AM), Access and Mobility Management Function (AMF), Code-Division Multiple Access (CDMA), Core Network (CN), Evolved Packet Core (EPC), Frequency Range 1 (FR1), Frequency Range 2 (FR2), Low-Noise Amplifier (LNA), SRS Resource Indicator (SRI), Transmission Configuration Indication (TCI), Time-Division Multiple Access (TDMA), Technical Specification (TS), User Plane Function (UPF), Vehicle-to-Vehicle (V2V), 5G Core Network (5GC), Multiple Downlink Control Information (M-DCI), Single Downlink Control Information (S-DCI), Dynamic-Grant (DG), Frequency Modulation (FM), Spatial Division Multiplexing (SDM), Simultaneous Transmission Across Multiple Panels (STxMP), Transmit Precoding Matrix Indicator (TPMI), Demodulation Reference Signal (DMRS, or DM-RS), Phase Tracking Reference Signal (PTRS, or PT-RS).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include a user equipment (UE) for wireless communication, comprising: at least one memory; and at least one processor coupled with the at least one memory and configured to cause the UE to: receive an indication for an uplink transmission that comprises at least one Physical Uplink Shared Channel (PUSCH) transmission associated with different Sounding Reference Signal (SRS) resource sets to be transmitted simultaneously; and determine parameters of Phase Tracking Reference Signal (PTRS) transmission for each of the at least one PUSCH transmission.

Some implementations of the method and apparatuses described herein may include a processor for wireless communication, comprising: at least one controller coupled with at least one memory and configured to cause the processor to: receive an indication for an uplink transmission that comprises at least one Physical Uplink Shared Channel (PUSCH)transmission associated with different Sounding Reference Signal (SRS) resource sets to be transmitted simultaneously; and determine parameters of Phase Tracking Reference Signal (PTRS) transmission for each of the at least one PUSCH transmission.

Some implementations of the method and apparatuses described herein may include a method performed by a user equipment (UE), the method comprising: receiving an indication for an uplink transmission that comprises at least one Physical Uplink Shared Channel (PUSCH)transmission associated with different Sounding Reference Signal (SRS) resource sets to be transmitted simultaneously; and determining parameters of Phase Tracking Reference Signal (PTRS) transmission for each of the at least one PUSCH transmission.

In some implementations of the method and apparatuses described herein, the indication is that the higher layer parameter multipanelScheme is configured and set to ‘SDMscheme’; the uplink transmission is one PUSCH transmission with different layers of the PUSCH transmission associated with different SRS resource sets; and the parameters comprise PUSCH to PTRS power ratio per layer per RE,

$${α}_{PTRS}^{PUSCH}$$

of a PTRS port.

In some implementations of the method and apparatuses described herein, the power ratio

$${α}_{PTRS}^{PUSCH}$$

of a PTRS port x is determined based on the number of PUSCH layers Lₓ which are coherently precoded with the PUSCH layer associated with the PTRS port x in the same SRS resource set as the PTRS port x, and a total number of scheduled PTRS ports Qp of the PUSCH transmission associated with different SRS resource sets.

In some implementations of the method and apparatuses described herein, the power ratio

$${α}_{PTRS}^{PUSCH}$$

is log(Lₓ)+10 log (Qₚ).

In some implementations of the method and apparatuses described herein, for ptrs-Power configured as ‘00’, the power ratio

$${α}_{PTRS}^{PUSCH}$$

of a PTRS port is 3*Qₚ−3 dB, if the number of PUSCH layers associated with a same SRS resource set as the PTRS port is one.

In some implementations of the method and apparatuses described herein, for ptrs-Power configured as ‘00’, the power ratio

$${α}_{PTRS}^{PUSCH}$$

of a PTRS port is 3*Qₚ dB for full coherent codebook based PUSCH, if the number of PUSCH layers associated with a same SRS resource set as the PTRS port is two.

In some implementations of the method and apparatuses described herein, for ptrs-Power configured as ‘00’, the power ratio

$${α}_{PTRS}^{PUSCH}$$

of a PTRS port is 3*Qₚ−3 dB for partial-coherent and non-coherent codebook based PUSCH and for non-codebook based PUSCH, if the number of PUSCH layers associated with a same SRS resource set as the PTRS port is two.

In some implementations of the method and apparatuses described herein, for ptrs-Power configured as ‘01’, the power ratio

$${α}_{PTRS}^{PUSCH}$$

a PTRS port is 3 dB, if the number of PUSCH layers associated with a same SRS resource set as the PTRS port is one.

In some implementations of the method and apparatuses described herein, for ptrs-Power configured as ‘01’, the power ratio

$${α}_{PTRS}^{PUSCH}$$

of a PTRS port is 6 dB, if the number of PUSCH layers associated with a same SRS resource set as the PTRS port is two.

In some implementations of the method and apparatuses described herein, the indication is that the higher layer parameter enableSTx2PofmDCI is configured; the uplink transmission is a plurality of PUSCH transmissions associated with different SRS resource sets; and the parameters comprise a maximum number of PTRS ports of each of the plurality of PUSCH transmissions.

In some implementations of the method and apparatuses described herein, a first parameter is received for configuring the maximum number of PTRS ports for non-overlapped PUSCH transmissions associated with different SRS resource sets, wherein value of the first parameter is one or two.

In some implementations of the method and apparatuses described herein, a second parameter is received for configuring the maximum number of PTRS ports for overlapped PUSCH transmissions associated with different SRS resource sets, wherein value of the second parameter is one.

In some implementations of the method and apparatuses described herein, an actual number of PTRS port is determined for each PUSCH transmission according to the first parameter or the second parameter based on whether the PUSCH transmissions associated with different SRS resource sets are overlapped or not.

In some implementations of the method and apparatuses described herein, a third parameter for configuring the maximum number of PTRS ports is received, and value of the third parameter is one or two.

In some implementations of the method and apparatuses described herein, if the maximum number of PTRS ports is two, and the PUSCH transmissions associated with different SRS resource sets are overlapped in time domain, an actual number of PTRS ports of each PUSCH transmission is determined as one.

In some implementations of the method and apparatuses described herein, if the maximum number of PTRS ports is two, and the PUSCH transmissions associated with different SRS resource sets are overlapped in time domain, only PTRS port 0 of each PUSCH transmission is transmitted.

In some implementations of the method and apparatuses described herein, it is not expected that indicated precoders or SRS resources result in more than one PTRS port where different PUSCH transmissions associated with different SRS resource sets are overlapped.

Some implementations of the method and apparatuses described herein may include a base station for wireless communication, comprising: at least one memory; and at least one processor coupled with the at least one memory and configured to cause the base station to: transmit an indication for an uplink transmission that comprises at least one Physical Uplink Shared Channel (PUSCH)transmission associated with different Sounding Reference Signal (SRS) resource sets to be transmitted simultaneously; and determine parameters of Phase Tracking Reference Signal (PTRS) transmission for reception of each of the at least one PUSCH transmission.

Some implementations of the method and apparatuses described herein may include a processor for wireless communication, comprising: at least one controller coupled with at least one memory and configured to cause the processor to: transmit an indication for an uplink transmission that comprises at least one Physical Uplink Shared Channel (PUSCH)transmission associated with different Sounding Reference Signal (SRS) resource sets to be transmitted simultaneously; and determine parameters of Phase Tracking Reference Signal (PTRS) transmission for reception of each of the at least one PUSCH transmission.

Some implementations of the method and apparatuses described herein may include a method performed by a base station for wireless communication, the method comprising: transmitting an indication for an uplink transmission that comprises at least one Physical Uplink Shared Channel (PUSCH)transmission associated with different Sounding Reference Signal (SRS) resource sets to be transmitted simultaneously; and determining parameters of Phase Tracking Reference Signal (PTRS) transmission for reception of each of the at least one PUSCH transmission.

In some implementations of the method and apparatuses described herein, the indication is that the higher layer parameter multipanelScheme is configured and set to ‘SDMscheme’; the uplink transmission is one PUSCH transmission with different layers of the PUSCH transmission associated with different SRS resource sets; and the parameters comprise PUSCH to PTRS power ratio per layer per RE,

$${α}_{PTRS}^{PUSCH}$$

of a PTRS port.

In some implementations of the method and apparatuses described herein, the power ratio

$${α}_{PTRS}^{PUSCH}$$

of a PTRS port x is determined based on the number of PUSCH layers Lₓ which are coherently precoded with the PUSCH layer associated with the PTRS port x in the same SRS resource set as the PTRS port x, and a total number of scheduled PTRS ports Qp of the PUSCH transmission associated with different SRS resource sets.

In some implementations of the method and apparatuses described herein, the power ratio

$${α}_{PTRS}^{PUSCH}$$

is 10 log(Lₓ)+10 log(Qₚ).

In some implementations of the method and apparatuses described herein, for ptrs-Power configured as ‘00’, the power ratio

$${α}_{PTRS}^{PUSCH}$$

of a PTRS port is 3*Qₚ−3 dB, if the number of PUSCH layers associated with a same SRS resource set as the PTRS port is one.

In some implementations of the method and apparatuses described herein, for ptrs-Power configured as ‘00’, the power ratio

$${α}_{PTRS}^{PUSCH}$$

of a PTRS port is 3*Qₚ dB for full coherent codebook based PUSCH, if the number of PUSCH layers associated with a same SRS resource set as the PTRS port is two.

In some implementations of the method and apparatuses described herein, for ptrs-Power configured as ‘00’, the power ratio

$${α}_{PTRS}^{PUSCH}$$

of a PTRS port is 3*Qₚ−3 dB for partial-coherent and non-coherent codebook based PUSCH and for non-codebook based PUSCH, if the number of PUSCH layers associated with a same SRS resource set as the PTRS port is two.

In some implementations of the method and apparatuses described herein, for ptrs-Power configured as ‘01’, the power ratio

$${α}_{PTRS}^{PUSCH}$$

of a PTRS port is 3 dB, if the number of PUSCH layers associated with a same SRS resource set as the PTRS port is one.

In some implementations of the method and apparatuses described herein, for ptrs-Power configured as ‘01’, the power ratio

$${α}_{PTRS}^{PUSCH}$$

of a PTRS port is 6 dB, if the number of PUSCH layers associated with a same SRS resource set as the PTRS port is two.

In some implementations of the method and apparatuses described herein, the indication is that the higher layer parameter enableSTx2PofmDCI is configured; the uplink transmission is a plurality of PUSCH transmissions associated with different SRS resource sets; and the parameters comprise a maximum number of PTRS ports of each of the plurality of PUSCH transmissions.

In some implementations of the method and apparatuses described herein, a first parameter is transmitted for configuring the maximum number of PTRS ports for non-overlapped PUSCH transmissions associated with different SRS resource sets, wherein value of the first parameter is one or two.

In some implementations of the method and apparatuses described herein, a second parameter is transmitted for configuring the maximum number of PTRS ports for overlapped PUSCH transmissions associated with different SRS resource sets, wherein value of the second parameter is one.

In some implementations of the method and apparatuses described herein, an actual number of PTRS port is determined for each PUSCH transmission according to the first parameter or the second parameter based on whether the PUSCH transmissions associated with different SRS resource sets are overlapped or not.

In some implementations of the method and apparatuses described herein, a third parameter for configuring the maximum number of PTRS ports is transmitted, and value of the third parameter is one or two.

In some implementations of the method and apparatuses described herein, if the maximum number of PTRS ports is two, and the PUSCH transmissions associated with different SRS resource sets are overlapped in time domain, an actual number of PTRS ports of each PUSCH transmission is determined as one.

In some implementations of the method and apparatuses described herein, if the maximum number of PTRS ports is two, and the PUSCH transmissions associated with different SRS resource sets are overlapped in time domain, only PTRS port 0 of each PUSCH transmission is received.

In some implementations of the method and apparatuses described herein, the base station only indicates precoders or SRS resources result in one PTRS port where different PUSCH transmissions associated with different SRS resource sets are overlapped.

### BRIEF DESCRIPTION OF THE DRAWINGS

FIG. 1 illustrates an example of a wireless communications system in accordance with aspects of the present disclosure.

FIG. 2 illustrates an example of a user equipment (UE) 200 in accordance with aspects of the present disclosure.

FIG. 3 illustrates an example of a processor 300 in accordance with aspects of the present disclosure.

FIG. 4 illustrates an example of a network equipment (NE) 400 in accordance with aspects of the present disclosure.

FIG. 5 illustrates examples of power boosting of a PTRS port of a PUSCH transmission with SDM scheme if maximum number of PTRS ports is configured as one in accordance with aspects of the present disclosure.

FIG. 6 illustrates examples of power boosting of a PTRS port of a PUSCH transmission with SDM scheme if maximum number of PTRS ports is configured as two in accordance with aspects of the present disclosure.

FIG. 7 illustrates a flowchart of method performed by a UE in accordance with aspects of the present disclosure.

FIG. 8 illustrates a flowchart of method performed by a NE in accordance with aspects of the present disclosure.

### DETAILED DESCRIPTION

Aspects of the present disclosure are described in the context of a wireless communications system.

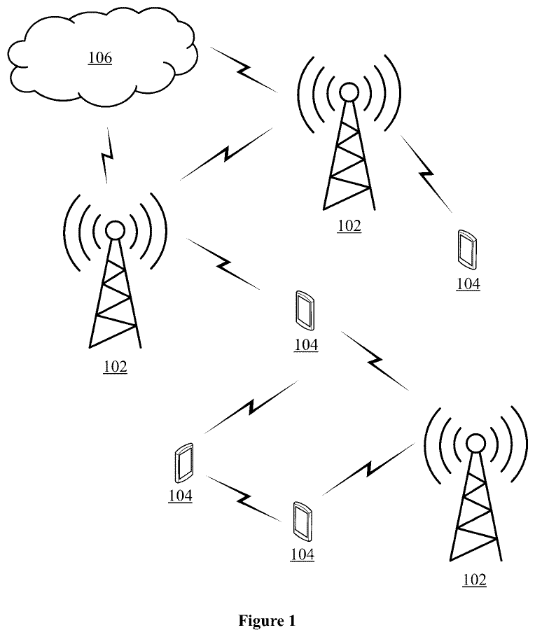

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

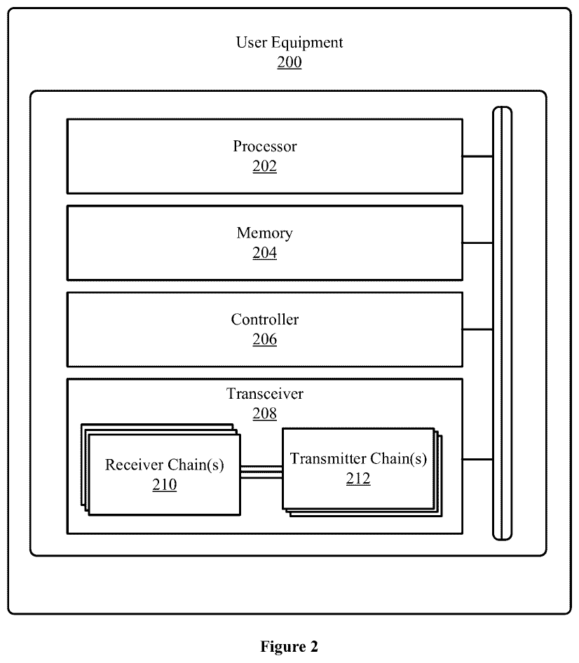

FIG. 2 illustrates an example of a UE 200 in accordance with aspects of the present disclosure. The UE 200 may include a processor 202, a memory 204, a controller 206, and a transceiver 208. The processor 202, the memory 204, the controller 206, or the transceiver 208, or various combinations thereof or various components thereof may be examples of means for performing various aspects of the present disclosure as described herein. These components may be coupled (e.g., operatively, communicatively, functionally, electronically, electrically) via one or more interfaces.

The processor 202, the memory 204, the controller 206, or the transceiver 208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 202 may include an intelligent hardware device (e.g., a general-purpose processor, a DSP, a CPU, an ASIC, an FPGA, or any combination thereof). In some implementations, the processor 202 may be configured to operate the memory 204. In some other implementations, the memory 204 may be integrated into the processor 202. The processor 202 may be configured to execute computer-readable instructions stored in the memory 204 to cause the UE 200 to perform various functions of the present disclosure.

The memory 204 may include volatile or non-volatile memory. The memory 204 may store computer-readable, computer-executable code including instructions when executed by the processor 202 cause the UE 200 to perform various functions described herein. The code may be stored in a non-transitory computer-readable medium such the memory 204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 202 and the memory 204 coupled with the processor 202 may be configured to cause the UE 200 to perform one or more of the functions described herein (e.g., executing, by the processor 202, instructions stored in the memory 204). For example, the processor 202 may support wireless communication at the UE 200 in accordance with examples as disclosed herein. The UE 200 may be configured to support a means for receiving an indication for an uplink transmission that comprises at least one Physical Uplink Shared Channel (PUSCH)transmission associated with different Sounding Reference Signal (SRS) resource sets to be transmitted simultaneously; and determining parameters of Phase Tracking Reference Signal (PTRS) transmission for each of the at least one PUSCH transmission.

The controller 206 may manage input and output signals for the UE 200. The controller 206 may also manage peripherals not integrated into the UE 200. In some implementations, the controller 206 may utilize an operating system such as iOS®, ANDROID®, WINDOWS®, or other operating systems. In some implementations, the controller 206 may be implemented as part of the processor 202.

In some implementations, the UE 200 may include at least one transceiver 208. In some other implementations, the UE 200 may have more than one transceiver 208. The transceiver 208 may represent a wireless transceiver. The transceiver 208 may include one or more receiver chains 210, one or more transmitter chains 212, or a combination thereof.

A receiver chain 210 may be configured to receive signals (e.g., control information, data, packets) over a wireless medium. For example, the receiver chain 210 may include one or more antennas for receive the signal over the air or wireless medium. The receiver chain 210 may include at least one amplifier (e.g., a low-noise amplifier (LNA)) configured to amplify the received signal. The receiver chain 210 may include at least one demodulator configured to demodulate the receive signal and obtain the transmitted data by reversing the modulation technique applied during transmission of the signal. The receiver chain 210 may include at least one decoder for decoding the processing the demodulated signal to receive the transmitted data.

A transmitter chain 212 may be configured to generate and transmit signals (e.g., control information, data, packets). The transmitter chain 212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 212 may also include at least one power amplifier configured to amplify the modulated signal to an appropriate power level suitable for transmission over the wireless medium. The transmitter chain 212 may also include one or more antennas for transmitting the amplified signal into the air or wireless medium.

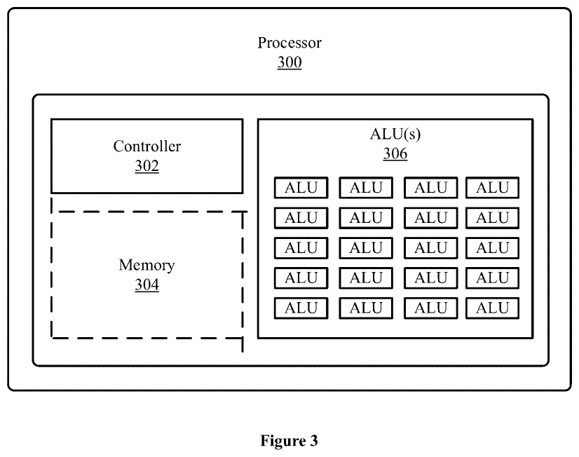

FIG. 3 illustrates an example of a processor 300 in accordance with aspects of the present disclosure. The processor 300 may be an example of a processor configured to perform various operations in accordance with examples as described herein. The processor 300 may include a controller 302 configured to perform various operations in accordance with examples as described herein. The processor 300 may optionally include at least one memory 304, which may be, for example, an L1/L2/L3 cache. Additionally, or alternatively, the processor 300 may optionally include one or more arithmetic-logic units (ALUs) 306. One or more of these components may be in electronic communication or otherwise coupled (e.g., operatively, communicatively, functionally, electronically, electrically) via one or more interfaces (e.g., buses).

The processor 300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 302 may be configured to manage and coordinate various operations (e.g., signaling, receiving, obtaining, retrieving, transmitting, outputting, forwarding, storing, determining, identifying, accessing, writing, reading) of the processor 300 to cause the processor 300 to support various operations in accordance with examples as described herein. For example, the controller 302 may operate as a control unit of the processor 300, generating control signals that manage the operation of various components of the processor 300. These control signals include enabling or disabling functional units, selecting data paths, initiating memory access, and coordinating timing of operations.

The controller 302 may be configured to fetch (e.g., obtain, retrieve, receive) instructions from the memory 304 and determine subsequent instruction(s) to be executed to cause the processor 300 to support various operations in accordance with examples as described herein. The controller 302 may be configured to track memory address of instructions associated with the memory 304. The controller 302 may be configured to decode instructions to determine the operation to be performed and the operands involved. For example, the controller 302 may be configured to interpret the instruction and determine control signals to be output to other components of the processor 300 to cause the processor 300 to support various operations in accordance with examples as described herein. Additionally, or alternatively, the controller 302 may be configured to manage flow of data within the processor 300. The controller 302 may be configured to control transfer of data between registers, arithmetic logic units (ALUs), and other functional units of the processor 300.

The memory 304 may include one or more caches (e.g., memory local to or included in the processor 300 or other memory, such RAM, ROM, DRAM, SDRAM, SRAM, MRAM, flash memory, etc. In some implementations, the memory 304 may reside within or on a processor chipset (e.g., local to the processor 300). In some other implementations, the memory 304 may reside external to the processor chipset (e.g., remote to the processor 300).

The memory 304 may store computer-readable, computer-executable code including instructions that, when executed by the processor 300, cause the processor 300 to perform various functions described herein. The code may be stored in a non-transitory computer-readable medium such as system memory or another type of memory. The controller 302 and/or the processor 300 may be configured to execute computer-readable instructions stored in the memory 304 to cause the processor 300 to perform various functions. For example, the processor 300 and/or the controller 302 may be coupled with or to the memory 304, the processor 300, the controller 302, and the memory 304 may be configured to perform various functions described herein. In some examples, the processor 300 may include multiple processors and the memory 304 may include multiple memories. One or more of the multiple processors may be coupled with one or more of the multiple memories, which may, individually or collectively, be configured to perform various functions herein.

The one or more ALUs 306 may be configured to support various operations in accordance with examples as described herein. In some implementations, the one or more ALUs 306 may reside within or on a processor chipset (e.g., the processor 300). In some other implementations, the one or more ALUs 306 may reside external to the processor chipset (e.g., the processor 300). One or more ALUs 306 may perform one or more computations such as addition, subtraction, multiplication, and division on data. For example, one or more ALUs 306 may receive input operands and an operation code, which determines an operation to be executed. One or more ALUs 306 be configured with a variety of logical and arithmetic circuits, including adders, subtractors, shifters, and logic gates, to process and manipulate the data according to the operation. Additionally, or alternatively, the one or more ALUs 306 may support logical operations such as AND, OR, exclusive-OR (XOR), not-OR (NOR), and not-AND (NAND), enabling the one or more ALUs 306 to handle conditional operations, comparisons, and bitwise operations.

The processor 300 may support wireless communication in accordance with examples as disclosed herein. The processor 300 may be configured to or operable to support a means for receiving an indication for an uplink transmission that comprises at least one Physical Uplink Shared Channel (PUSCH)transmission associated with different Sounding Reference Signal (SRS) resource sets to be transmitted simultaneously; and determining parameters of Phase Tracking Reference Signal (PTRS) transmission for each of the at least one PUSCH transmission.

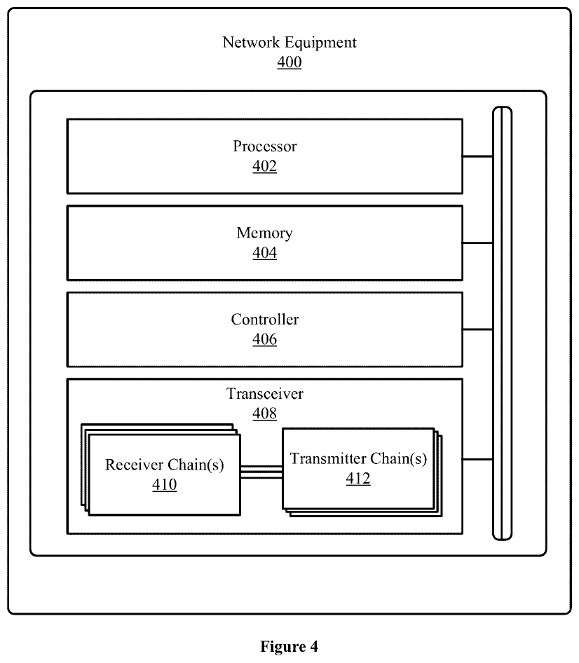

FIG. 4 illustrates an example of a NE 400 in accordance with aspects of the present disclosure. The NE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the NE 400 to perform various functions of the present disclosure.

The memory 404 may include volatile or non-volatile memory. The memory 404 may store computer-readable, computer-executable code including instructions when executed by the processor 402 cause the NE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the NE 400 to perform one or more of the functions described herein (e.g., executing, by the processor 402, instructions stored in the memory 404). For example, the processor 402 may support wireless communication at the NE 400 in accordance with examples as disclosed herein. The NE 400 may be configured to support a means for transmitting an indication for an uplink transmission that comprises at least one Physical Uplink Shared Channel (PUSCH)transmission associated with different Sounding Reference Signal (SRS) resource sets to be transmitted simultaneously; and determining parameters of Phase Tracking Reference Signal (PTRS) transmission for reception of each of the at least one PUSCH transmission.

The controller 406 may manage input and output signals for the NE 400. The controller 406 may also manage peripherals not integrated into the NE 400. In some implementations, the controller 406 may utilize an operating system such as iOS®, ANDROID®, WINDOWS®, or other operating systems. In some implementations, the controller 406 may be implemented as part of the processor 402.

In some implementations, the NE 400 may include at least one transceiver 408. In some other implementations, the NE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

In Release 18, single-DCI based SDM PUSCH transmission where different layers of a PUSCH transmission are transmitted by different panels simultaneously and multi-DCI based PUSCH+PUSCH scheme where different PUSCH transmissions are transmitted by different panels simultaneously are supported. Orthogonal phase tracking reference signal (PTRS) is required for phase noise estimation for different panels.

In the disclosure, the PUSCH transmitted from different panels means the PUSCH is transmitted from different panels based on different SRS resource sets or different beams (e.g., spatial relation or UL TCI states, or DLorJoint-TCIState specified in Technical Specifications 38.331) or PUSCHs are associated with different CORESETPoolIndex values.

It was proposed that for single-DCI based STxMP PUSCH transmission with SDM scheme, PUSCH transmission corresponding to one panel (i.e., PUSCH corresponding to one SRS resource set) shall be rate matched around the PTRS port corresponding to the other panel as that in Release 15. In such case, the power boosting of a PTRS port may be different from the current specification for single-panel based PUSCH transmission since only the power of muted REs of a same panel may be used for power boosting of a PTRS port. The PTRS power boosting issue in STxMP SDM based PUSCH transmission needs to be addressed.

Besides, there is an agreement on the restriction of the maximum number of PTRS ports of a PUSCH transmission being one in multi-DCI based STxMP PUSCH+PUSCH transmission. The motivation of such restriction is to ensure the maximum total number of PTRS ports is two even when two overlapped PUSCH transmissions are scheduled. If the scheduled PUSCH transmissions corresponding to different panels are non-overlapped in the time domain, the number of PTRS ports of a PUSCH transmission corresponding to one panel may be up to two as in legacy to ensure the performance when a non-overlapped PUSCH transmission is scheduled with high rank. Whether the PUSCH transmissions from different panels overlap or not may dynamically depend on the scheduling DCIs. Thus, solutions are needed to ensure the number of PTRS ports of a PUSCH transmission is one in multi-DCI based STxMP PUSCH+PUSCH transmission.

In the present Technical Specifications (TS) of the Third Generation Partnership Project (3GPP), the following are provided.

6.2.3.1 UE PT-RS Transmission Procedure when Transform Precoding is not Enabled in TS 38.214

The maximum number of configured PT-RS ports is given by the higher layer parameter maxNrofPorts in PTRS-UplinkConfig. The UE is not expected to be configured with a larger number of UL PT-RS ports than it has reported need for.

If a UE has reported the capability of supporting full-coherent UL transmission, the UE shall expect the number of UL PT-RS ports to be configured as one if UL-PTRS is configured.

For codebook or non-codebook based UL transmission, the association between UL PT-RS port(s) and DM-RS port(s) is signalled by PTRS-DMRS association field in DCI format 0_1 and DCI format 0_2. For a PUSCH corresponding to a configured grant Type 1 transmission, the UE may assume the association between UL PT-RS port(s) and DM-RS port(s) defined by value 0 in Table 7.3.1.1.2-25 or value “00” in Table 7.3.1.1.1.2-26 described in Clause 7.3.1 of [5, TS38.212].

For PUSCH scheduled by DCI format 0_0 or by activation DCI format 0_0, the UL PT-RS port is associated to DM-RS port 0.

For non-codebook based UL transmission, the actual number of UL PT-RS port(s) to transmit is determined based on SRI(s) in DCI format 0_1 and DCI format 0_2 or higher layer parameter sri-ResourceIndicator in rrc-ConfiguredUplinkGrant. A UE is configured with the PT-RS port index for each configured SRS resource by the higher layer parameter ptrs-PortIndex configured by SRS-Config if the UE is configured with the higher layer parameter phaseTrackingRS in DMRS-UplinkConfig. If the PT-RS port index associated with different SRIs are the same, the corresponding UL DM-RS ports are associated to the one UL PT-RS port.

For partial-coherent and non-coherent codebook-based UL transmission, the actual number of UL PT-RS port(s) is determined based on TPMI and/or number of layers which are indicated by ‘Precoding information and number of layers’ field in DCI format 0_1 and DCI format 0_2 or configured by higher layer parameter precodingAndNumberOfLayers:
if the UE is configured with the higher layer parameter maxNrofPorts in PTRS-UplinkConfig set to ‘n2’, the actual UL PT-RS port(s) and the associated transmission layer(s) are derived from indicated TPMI as:
PUSCH antenna port 1000 and 1002 in indicated TPMI share PT-RS port 0, and PUSCH antenna port 1001 and 1003 in indicated TPMI share PT-RS port 1.
UL PT-RS port 0 is associated with the UL layer ‘x’ of layers which are transmitted with PUSCH antenna port 1000 and PUSCH antenna port 1002 in indicated TPMI, and UL PT-RS port 1 is associated with the UL layer ‘y’ of layers which are transmitted with PUSCH antenna port 1001 and PUSCH antenna port 1003 in indicated TPMI, where ‘x’ and/or ‘y’ are given by DCI parameter ‘PTRS-DMRS association’ as shown in DCI format 0_1 and DCI format 0_2 described in Clause 7.3.1 of [5, TS38.212].

When the UE is scheduled with Qₚ={1,2} PT-RS port(s) in uplink and the number of scheduled layers is

$${n}_{layer}^{PUSCH} ,$$

If the UE is configured with higher layer parameter ptrs-Power, the PUSCH to PT-RS power ratio per layer per RE

$${ρ}_{PTRS}^{PUSCH}$$

is given by

$${ρ}_{PTRS}^{PUSCH} = - {α}_{PTRS}^{PUSCH} [ dB ] ,$$

where

$${α}_{PTRS}^{PUSCH}$$

is shown in the Table 6.2.3.1-3 according to the higher layer parameter ptrs-Power, the PT-RS scaling factor β_{RTRS} specified in clause 6.4.1.2.2.1 of [4, TS 38.211] is given by

$${β}_{PTRS} = 1 {0}^{- \frac{{ρ}_{PTRS}^{PUSCH}}{20}}$$

and also on the ‘Precoding Information and Number of Layers’ field in DCI.
The UE shall assume ptrs-Power in PTRS-UplinkConfig is set to state “00” in Table 6.2.3.1-3 if not configured or in case of non-codebook based PUSCH.

TABLE 6.2.3.1-3
$Factor related to PUSCH to PT - RS power ratio per layer per RE {α}_{PTRS}^{PUSCH}$

| | | $The number of PUSCH layers ( {n}_{layer}^{PUSCH} )$ | | | | | | |
|---|---|---|---|---|---|---|---|---|
| | | 2 | | 3 | | | | |
| | | | Partial and | | Partial and | 4 | | |
| | | | non- | | non- | | | Non- |
| UL-PTRS- | | | coherent | | coherent | | | coherent |
| power/ | 1 | | and non- | | and non- | | | and non- |
| ${α}_{PTRS}^{PUSCH}$ | All cases | Full coherent | codebook based | Full coherent | codebook based | Full coherent | Partial coherent | codebook based |
| 00 | 0 | 3 | 3Qₚ-3 | 4.77 | 3Qₚ-3 | 6 | 3Qₚ | 3Qₚ-3 |
| 01 | 0 | 3 | 3 | 4.77 | 4.77 | 6 | 6 | 6 |

| | |
|---|---|
| 10 | Reserved |
| 11 | Reserved |

The present disclosure provides methods to resolve the PTRS issues in simultaneous multi-panel transmission, at least in relation to PTRS power boosting in SDM PUSCH transmission, and ensuring that the maximum number of PTRS ports of a PUSCH transmission is one in M-DCI based STxMP PUSCH+PUSCH transmission when PUSCH transmissions from different panels are overlapped.

### PTRS Power Boosting in SDM PUSCH Transmission

In NR, different PTRS ports of a PUSCH transmission occupy different REs in the frequency domain and are transmitted on different layers of the PUSCH transmission. Power boosting of PTRS is specified in Release 15 to ensure the phase noise estimation performance. In up to Release 17, PTRS power boosting (i.e., PUSCH to PT-RS power ratio per layer per RE

$${α}_{PTRS}^{PUSCH} )$$

is determined based on the number of PUSCH layers and coherent types of indicated precoder (i.e., full-coherent, partial-coherent or non-coherent) and the number of PTRS ports scheduled to the UE. For non-codebook based PUSCH transmission, PTRS power boosting is the same as non-coherent codebook PUSCH transmission.

For S-DCI based SDM PUSCH transmission, different PUSCH layers of a same PUSCH are transmitted by different panels. That means different layers of a PUSCH transmission are transmitted based on different TCI states or SRS resources in different SRS resource sets. If two SRS resource sets for codebook or non-codebook based PUSCH transmission are configured and multi-panel scheme is configured as ‘SDMscheme’ (i.e., the higher layer parameter multipanelScheme is configured and set to ‘SDMscheme’) with SRS resource set indicator in scheduling DCI being ‘10’, it is identified as an SDM PUSCH transmission. For codebook based STxMP SDM PUSCH, the scheduling DCI contains two TPMI fields, and each TPMI field separately indicates the precoding information and the number of layers conveyed over the SRS ports of the indicated SRS resource in each SRS resource set. For non-codebook based STxMP SDM PUSCH, two SRI fields are contained in the scheduling DCI and each field indicates the SRS resource(s) in each SRS resource set for the UE to determine the precoding matrix of the PUSCH layer associated with each SRS resource set, respectively.

Based on the agreed rank combination for STxMP SDM PUSCH, the number of layers of the PUSCH transmitted from different panels (or transmitted corresponding to different SRS resource sets) may be different, e.g., layer combinations of {1+2} and {2+1} where the number of PUSCH layers from one panel is 1 and that from another panel is 2; and the power boosting of PTRS ports corresponding to different panels may be different when it is assumed that the power boosting may only be performed among REs of a same panel. Therefore, for S-DCI based SDM PUSCH transmission, the PTRS power boosting of a PTRS port from a panel shall be determined based on the number of PUSCH layers and the coherent type of precoder of the PUSCH transmission from a same panel. In other words, when determining the power boosting of a PTRS port of PUSCH transmission based on an SRS resource set, the number of PUSCH layers and the coherent type are based on the TPMI field or SRI filed associated with the same SRS resource set.

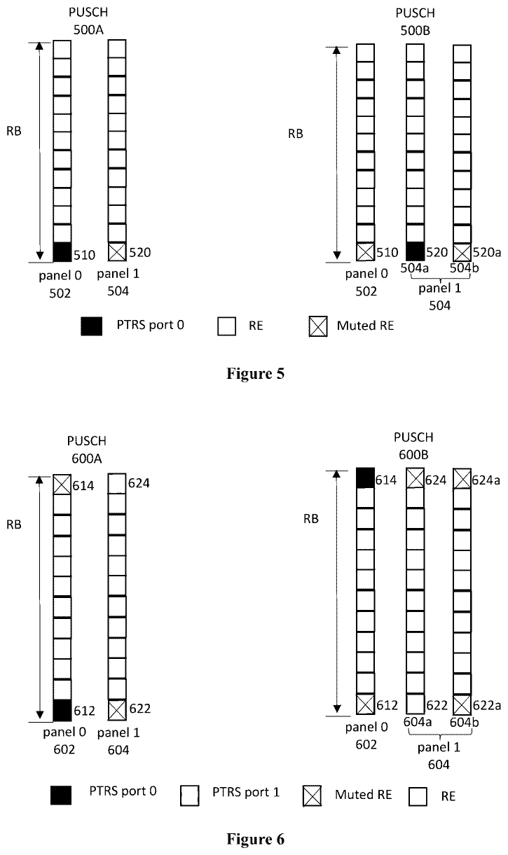

For single-DCI based STxMP PUSCH SDM scheme, the layer combinations of {1+1, 1+2, 2+1 and 2+2} are supported. When the maximum number of PTRS ports (e.g., maxNrofPortsforSdm) is configured as 1, examples of the PTRS power boosting of layer combinations of {1+1, and 1+2} are illustrated as in FIG. 5.

In the examples shown in FIG. 5, the maximum number of PTRS ports is one and the PTRS transmission may be transmitted from panel 0 or panel 1 based on the associated DMRS port; and the PUSCH transmission from a panel is rate matched around REs of the PTRS port from another panel.

For PUSCH transmission 500A where the number of layers of the PUSCH transmission from each panel (i.e., panel 0 502 and panel 1 504) is one, PTRS port 0 of the PUSCH transmission is transmitted on RE 510 of panel 0 502, while RE 520 of panel 1 504 is muted. In this example, even though there is a muted RE 520, the power of PTRS port 0 cannot be boosted since the power muted RE 520 and PTRS port 0 are transmitted by different panels and there is no muted RE in the same panel (i.e., panel 0 502) for boosting the PTRS port 0 transmission.

For PUSCH transmission 500B where the number of layers of the PUSCH transmission from panel 0 502 is one and that from panel 1 504 is two (i.e., layers 504a and 504b), PTRS port 0 of the PUSCH transmission is transmitted on RE 520 of layer 504a of panel 1 504, while RE 510 of panel 0 502 and RE 520a of layer 504b of panel 1 504 are both muted. In this example, the power of the muted RE 520a in the same panel (i.e., panel 1 504) may be used for the power boosting of PTRS port 0 when the two layers 504a and 504b are full-coherent.

Therefore, in the case where the maximum number of PTRS ports is configured as 1, when the PTRS port of a PUSCH transmission is transmitted from a panel with a single PUSCH layer, the power boosting of the PTRS port

$$( i . e . , {α}_{PTRS}^{PUSCH} )$$

is 0 dB. When the PTRS port of a PUSCH transmission is transmitted from a panel with two PUSCH layers, the power boosting of the PTRS port depends on the coherent type of the indicated precoder. Specifically, for the case where the two layers of a codebook based PUSCH transmission are partial-coherent or non-coherent (i.e., the TPMI associated with the same SRS resource set as the PTRS port is partial-coherent or non-coherent) or of a non-codebook based PUSCH transmission, the power of muted RE on the other layer cannot be borrowed for the PTRS transmission as that in Release 17, i.e.,

$${α}_{PTRS}^{PUSCH}$$

is 0 dB. For the case where the two layers of a codebook based PUSCH transmission are full-coherent (i.e., the TPMI associated with the same SRS resource set as the PTRS port is full-coherent), the power of muted RE on the other layer may be borrowed for the PTRS transmission, i.e.,

$${α}_{PTRS}^{PUSCH}$$

### IS 3 dB.

When the maximum number of PTRS ports (e.g., mnaxNrofPortsforSdm) is configured as 2, examples of the PTRS power boosting of layer combinations of {1+1, and 1+2} are illustrated as in FIG. 6.

In the examples shown in FIG. 6, the maximum number of PTRS ports is configured as two, the actual number of PTRS ports of a PUSCH transmission is two and each PTRS port is associated with a DMRS port associated with a TPMI or SRI field.

For PUSCH transmission 600A where the number of layers of the PUSCH transmission from each panel (i.e., panel 0 602 and panel 1 604) is one, two PTRS ports (i.e., PTRS ports 0 and 1) are transmitted on RE 612 of panel 0 602 and on RE 624 of panel 1 604, respectively, while their corresponding resources RE 622 of panel 1 604 and RE 614 of panel 0 602 are muted. In this example, the power of the muted RE 614 may be used for power boosting of PTRS port 0 in the same panel (i.e., panel 0 602); and the power of the muted RE 622 may be used for the power boosting of PTRS port 1 in the same panel (i.e., panel 1 604).

For PUSCH transmission 600B, the number of layers of the PUSCH transmission from panel 0 602 is one and that from panel 1 604 is two (i.e., layers 604a and 604b). Two PTRS ports (i.e., PTRS ports 0 and 1) are transmitted on RE 614 of panel 0 602 and on RE 622 of layer 604a of panel 1 604, respectively, while their corresponding resources RE 624 and RE 624a of panel 1 604, and RE 612 of panel 0 602 and RE 622a of layer 604b of panel 1 604 are all muted. In this example, the power of the muted RE 612 may be used for the power boosting of PTRS port 0 in the same panel (i.e., panel 0 602); and the power of the muted RE 622a, RE 624, and RE 624a may be used for the power boosting of PTRS port 1 in the same panel (i.e., panel 1 604) when the two layers 604a and 604b are full-coherent.

The PUSCH transmission from a panel is rate matched around REs of PTRS ports from both panels. Even though the PTRS port of a panel cannot borrow the power from muted REs of the other panel, the power of the PTRS port may still be boosted by borrowing the power of muted REs of the same panel. Therefore, in the case where the maximum number of PTRS ports is configured as 2, when a PTRS port of a PUSCH transmission is transmitted from a panel with a single PUSCH layer, the power boosting of the PTRS port

$$( i . e . , {α}_{PTRS}^{PUSCH} )$$

is 3 dB; when a PTRS port of a PUSCH transmission is transmitted from a panel with two PUSCH layers, the power boosting of the PTRS port depends on the coherent type of the indicated precoder. Specifically, for the case that when the two layers of a codebook based PUSCH transmission are partial-coherent or non-coherent (i.e., the TPMI associated with the same SRS resource set as the PTRS port is partial-coherent or non-coherent) or of a non-codebook based PUSCH transmission, the

$${α}_{PTRS}^{PUSCH}$$

is 3 dB, and for the case that when the two layers of a codebook based PUSCH transmission are full-coherent (i.e., the TPMI associated with the same SRS resource set as the PTRS port is full-coherent), the

$${α}_{PTRS}^{PUSCH}$$

is 6 dB.

Accordingly, the power boosting of PTRS port in S-DCI based SDM PUSCH transmission may be summarised as Table 1 below, where Qₚ is the configured maximum number of PTRS ports or the total number of actual PTRS ports across different panels, and the coherent type is the precoder indicated for the PUSCH transmission from the same panel as the PTRS port.

TABLE 1
$Factor related to PUSCH to PT - RS power ratio per layer per RE {α}_{PTRS}^{PUSCH} for$
SDM PUSCH transmission

| | $The number of PUSCH layers ( {n}_{layer}^{PUSCH} ) associated with an SRS$ | | |
|---|---|---|---|
| UL-PTRS- | resource set | | |
| power/ | 1 | 2 | |
| ${α}_{PTRS}^{PUSCH}$ | All cases | Full coherent | Partial and non-coherent and non-codebook based |
| 00 | 3Qₚ-3 | 3Qₚ | 3Qₚ-3 |
| 01 | 3 | 6 | 6 |

| | |
|---|---|
| 10 | Reserved |
| 11 | Reserved |

That is, the power boosting of a PTRS port x in SDM PUSCH transmission is 10 log(Lₓ)+10 log(Qₚ) or 10 log(LₓQₚ), where Lₓ is the number of PUSCH layers which are coherently precoded with the PUSCH layer associated with the PTRS port x in the same SRS resource set as the PTRS port x, and Qₚ is the configured maximum number of PTRS ports or the total number of scheduled or actual PTRS ports of the PUSCH transmission associated with different SRS resource sets.

The power boosting of PTRS port corresponding to different panels may be different. Therefore, the power boosting shall be determined for each PTRS port separately based on Table 1 or the above formula.

Based on the above, the UE may receive an indication (i.e., multipanelScheme is set to ‘SDMscheme’) from the gNB for indicating a PUSCH transmission is an S-DCI based SDM PUSCH transmission with different layers of the PUSCH transmission associated with different SRS resource sets; and the UE may determine the power boosting of a PTRS port of the PUSCH transmission (i.e., PUSCH to PTRS power ratio per layer per RE

$${α}_{PTRS}^{PUSCH}$$

of the PTRS port).

The power ratio

$${α}_{PTRS}^{PUSCH}$$

of a PTRS port x is determined based on the number of PUSCH layers Lₓ which are coherently precoded with the PUSCH layer associated with the PTRS port x in the same SRS resource set as the PTRS port x, and a total number of scheduled PTRS ports Qₚ of the PUSCH transmission associated with different SRS resource sets.

For ptrs-Power configured as ‘00’ (i.e., the first column of Table 1), the power ratio

$${α}_{PTRS}^{PUSCH}$$

of a PTRS port is 3*Qₚ−3 dB, if the number of PUSCH layers associated with a same SRS resource set as the PTRS port is one; for ptrs-Power configured as ‘00’, the power ratio

$${α}_{PTRS}^{PUSCH}$$

of a PTRS port is 3*Qₚ dB for full coherent codebook based PUSCH, if the number of PUSCH layers associated with a same SRS resource set as the PTRS port is two; for ptrs-Power configured as ‘00’, the power ratio

$${α}_{PTRS}^{PUSCH}$$

of a PTRS port is 3*Qₚ−3 dB for partial-coherent and non-coherent codebook based PUSCH and for non-codebook based PUSCH, if the number of PUSCH layers associated with a same SRS resource set as the PTRS port is two. For ptrs-Power configured as ‘01’, in some embodiments, the power ratio

$${α}_{PTRS}^{PUSCH}$$

of a PTRS port is 3 dB, if the number of PUSCH layers associated with a same SRS resource set as the PTRS port is one; for ptrs-Power configured as ‘01’, the power ratio

$${α}_{PTRS}^{PUSCH}$$

of a PTRS port is 6 dB, if the number of PUSCH layers associated with a same SRS resource set as the PTRS port is two. For ptrs-Power configured as ‘01’, in some other embodiments, the power ratio

$${α}_{PTRS}^{PUSCH}$$

of a PTRS port is 3*Qₚ−3 dB, if the number of PUSCH layers associated with a same SRS resource set as the PTRS port is one; for ptrs-Power configured as ‘01’, the power ratio

$${α}_{PTRS}^{PUSCH}$$

of a PTRS port is 3*Qₚ dB, if the number of PUSCH layers associated with a same SRS resource set as the PTRS port is two.

In an example (i.e. Example 1), it is assumed that multi-panel scheme is configured as ‘SDMschenie’ and the mnaxNrofPortsforSDM is 2; and two SRS resource sets for codebook based PUSCH transmission are configured and the number of SRS ports is 4. A DCI format 0_1 schedules a 3-layer SDM PUSCH transmission and the first TPMI field indicates the precoder

$$\frac{1}{2} [ \begin{matrix}1 \\ 0 \\ 1 \\ 0\end{matrix} ]$$

for one layer of the PUSCH transmission from panel 0 based on SRS resources in the first SRS resource set and the second TPMI field indicates the precoder

$$\frac{1}{2} [ \begin{matrix}1 & 0 \\ 0 & 1 \\ 1 & 0 \\ 0 & j\end{matrix} ]$$

for two layers of the PUSCH transmission from panel 1 based on SRS

resources in the second SRS resource set. The actual number of PTRS ports is 2 and PTRS port 0 is associated with the one layer from panel 0 and the PTRS port 1 is associated with the first layer from panel 1, which is similar to the example of PUSCH 600B in FIG. 6. Then, for PTRS port 0, the power may be boosted 3 dB from the power of muted RE (i.e., RE 612) corresponding to PTRS port 1; and for PTRS port 1, since the indicated precoder is partial-coherent, the power of PTRS port 1 may only be boosted 3 dB from the power of muted RE (i.e., RE 624) corresponding to PTRS port 0 on the same layer. If the second TPMI field indicates a full-coherent precoder, e.g.,

$$\frac{1}{2 \sqrt{2}} [ \begin{matrix}1 & 1 \\ 1 & 1 \\ 1 & - 1 \\ 1 & - 1\end{matrix} ] ,$$

the power of PTRS port 1 may be boosted 6 dB from the power of muted REs corresponding to PTRS port 0 on the two layers.

### PTRS Port in M-DCI Based PUSCH+PUSCH Transmission

In Release 17, PUSCH scheduled by DCI associated with different CORESETPoolIndex values shall be non-overlapped in the time domain, and the number of PTRS ports of a PUSCH transmission may be up to two. In Release 17, the actual number of transmitted PTRS ports is determined based on the TPMI(s) and/or number of layers and coherent type (for codebook based PUSCH transmission), or based on indicated SRS resources (for non-codebook based PUSCH transmission). In Release 18, two PUSCH transmissions scheduled by DCI or CG PUSCH associated with different CORESETPoolIndex values (that means PUSCH transmissions are transmitted based on different SRS resource sets) may be fully or partially overlapped in the time domain, but the number of PTRS ports may only be up to one for each PUSCH transmission in PUSCH+PUSCH transmission. If two SRS resource sets for codebook or non-codebook based PUSCH transmission are configured and enableSTx2PofmDCI (which means PUSCH transmissions from different panels can be overlapped in the time domain in M-DCI scenario) is configured, and PUSCH transmissions are associated with different values of CORESETPoolIndex, it is identified as M-DCI based PUSCH+PUSCH transmissions. Whether the PUSCH transmissions from different panels with different CORESETPoolIndex values overlap or not may depend on the scheduling DCIs dynamically. Then, if the PUSCH transmissions from different panels are overlapped in the time domain, there is a need to ensure the maximum number of PTRS port of each PUSCH transmission is one. The following schemes are provided. In these schemes, the UE may receive an indication (i.e., enableSTx2PofmDCI is configured) for a plurality of PUSCH transmissions that are associated with different SRS resource sets; and the UE may determine the maximum number of PTRS ports of each PUSCH transmission.

In the first scheme, two RRC parameters are used to configure the maximum number of PTRS ports in M-DCI based PUSCH+PUSCH transmission.

In this scheme, an additional RRC parameter, for example maxNrofPortsofSTx, may be configured to UE. The legacy parameter maxNrofPorts (i.e., a first parameter) may be used to configure the maximum number of PTRS ports for a PUSCH transmission which is not overlapped with other PUSCH transmission from a different panel with a different CORESETPoolIndex value and the value of this parameter may be n1 or n2, where n1 may be one and n2 may be two. The new parameter maxNrofPortsofSTx (i.e., a second parameter) is used to configure the maximum number of PTRS ports for a PUSCH transmission which is overlapped with at least one PUSCH transmission associated a different CORESETPoolIndex value and the value of this parameter may be n1. If a UE transmits a PUSCH from a panel and determines that there is no overlapped PUSCH transmission from another panel, then the UE determines the actual number of PTRS ports based on the legacy parameter; and if UE transmits two overlapped PUSCH transmissions from different panels with different CORESETPoolIndex values, then the UE determines the number of PTRS ports for each PUSCH transmission based on the new parameter.

In the second scheme, one RRC parameter is used to configure the maximum number of PTRS ports in M-DCI based PUSCH+PUSCH transmission.

In this scheme, one parameter (i.e. a third parameter), for example the legacy parameter maxNrofPorts, is used to configure the maximum number of PTRS ports for each PUSCH transmission in M-DCI scenario. Since for non-overlapped PUSCH transmissions from different panels, the maximum number of PTRS ports may be up to two, so the value of the parameter may be n1 or n2. If the maximum number of PTRS ports is configured as n2, the following two approaches are proposed to ensure the maximum number of PTRS port of each PUSCH transmission is 1 if the UE transmits two overlapped PUSCHs from different panels.

As the first approach of the scheme, the UE always assumes that the actual number of PTRS ports of a PUSCH transmission is 1 for STxMP PUSCH+PUSCH transmission.

In the current standard, the actual number of PTRS ports is determined based on the indicated precoder (for codebook based PUSCH transmission) or the indicated SRS resources (for non-codebook based PUSCH transmission). Specifically, for partial-coherent and non-coherent codebook-based PUSCH transmissions, the actual number of PTRS ports is determined based on the indicated TPMI and/or number of layers, where PUSCH antenna ports 1000 and 1002 in indicated TPMI share PTRS port 0, and PUSCH antenna port 1001 and 1003 in indicated TPMI share PTRS port 1; for non-codebook PUSCH, the actual number of PTRS ports is determined based on indicated SRS resource(s), where each SRS resource is configured with a PTRS port index.

Therefore, in M-DCI based PUSCH+PUSCH transmission, if the PUSCH transmissions from different panels with different CORESETPoolIndex values are non-overlapped, the legacy procedure for determining the actual number of PTRS ports is applied; if the PUSCH transmissions from different panels with different CORESETPoolIndex values are overlapped, the UE always determines the actual number of PTRS ports for each PUSCH transmission is 1 regardless of the indicated precoders (for codebook based PUSCH transmission) or SRS resources (for non-codebook based PUSCH transmission), and the UE transmits the one PTRS port (i.e., PTRS port 0) of each PUSCH transmission associated with a CORESETPoolIndex value.

In an example (i.e., Example 2), it is assumed that enableSTx2PofmDCI, which means PUSCH transmissions from different panels can be overlapped in the time domain in M-DCI scenario, is configured. Two SRS resource sets for codebook based transmission are configured and the number of SRS ports is 4. PDCCH-Config contains two different values of CORESETPoolIndex in ControlResourceSet in the active BWP and the configured maximum number of PTRS ports is 2. A DCI #0 associated with CORESETPoolIndex 0 schedules a PUSCH transmission #0 and the TPMI field indicates the precoder

$$\frac{1}{2} [ \begin{matrix}1 & 0 \\ 0 & 0 \\ 0 & 1 \\ 0 & 0\end{matrix} ]$$

for PUSCH transmission #0 from panel 0 based on SRS resources in the first SRS resource set. A DCI #1 associated with CORESETPoolIndex 1 schedules a PUSCH transmission #1 and the TPMI field indicates the precoder

$$\frac{1}{2} [ \begin{matrix}1 & 0 \\ 0 & 1 \\ 0 & 0 \\ 0 & 0\end{matrix} ]$$

for PUSCH transmission #1 from panel 1 based on SRS resources in the second SRS resource set. Then, if PUSCH transmission #0 and PUSCH transmission #1 are non-overlapped, the actual number of PTRS ports of PUSCH transmission #0 is 1 since PUSCH antenna ports 1000 and 1002 share a same PTRS port and the actual number of PTRS ports of PUSCH transmission #1 is 2 since PUSCH antenna ports 1000 and 1001 are of different PTRS ports; and if PUSCH transmission #0 and PUSCH transmission #1 are overlapped in the time domain, the actual number of PTRS ports of each PUSCH transmission is 1.

In this approach, the UE determines the actual number of PTRS ports of a PUSCH transmission depending on whether the PUSCH transmission overlaps with another PUSCH transmission with a different CORESETPoolIndex value or not.

As the second approach of the second scheme, the UE always transmits PTRS port 0 for each PUSCH transmission in M-DCI based STxMP PUSCH+PUSCH transmission.

In this approach, the UE determines the actual number of PTRS ports based on the legacy procedure as explained in the first approach. If PUSCH transmissions from different panels with different CORESETPoolIndex values are overlapped in the time domain and the actual number of PTRS ports of a PUSCH transmission is 2, the UE always transmits PTRS port 0 of the PUSCH transmission. For example, as in Example 2, if PUSCH transmission #0 and PUSCH transmission #1 are overlapped, the UE determines the actual number of PTRS ports for PUSCH transmission #0 and PUSCH transmission #1 are 1 and 2, respectively, based on the legacy procedure, but the UE only transmits PTRS port 0 of PUSCH transmission #0 and PTRS port 0 of PUSCH transmission #1. In this approach, the UE determines the actual number of PTRS ports based on the legacy procedure, but only transmits PTRS port 0 when PUSCH transmissions from different panels with different CORESETPoolIndex values are overlapped in the time domain.

The third scheme to ensure the maximum number of PTRS port of each PUSCH transmission is 1 involves gNB implementation. In this scheme, the gNB only indicates some precoders (for codebook based PUSCH) or SRI combination (for non-codebook based PUSCH) that cause the actual number of PTRS ports to be 1. That is, if two SRS resource sets for codebook or non-codebook based PUSCH transmission are configured and the higher layer parameter enableSTx2PofmDCI is configured, and two different CORESETPoolIndex values in ControlResourceSet are configured, the UE expects that the indicated precoders or the SRS resources for a PUSCH transmission result in one PTRS port if different PUSCH transmissions from different panels are overlapped. That is, the UE does not expect that indicated precoders or SRS resources result in more than one PTRS port where different PUSCH transmissions associated with different SRS resource sets are overlapped. For example, for 2-layer codebook based PUSCH transmission with the number of SRS ports being 2, the UE expects that the precoder is one of

$$\frac{1}{\sqrt{2}} [ \begin{matrix}1 & 1 \\ 1 & - 1\end{matrix} ] , \frac{1}{\sqrt{2}} [ \begin{matrix}1 & 1 \\ j & - j\end{matrix} ] ;$$

for 2-layer codebook PUSCH transmission with the number of SRS ports being 4, the UE expects that the precoder is one of

$$\frac{1}{2} [ \begin{matrix}1 & 0 \\ 0 & 0 \\ 0 & 1 \\ 0 & 0\end{matrix} ] , \frac{1}{2} [ \begin{matrix}0 & 0 \\ 1 & 0 \\ 0 & 0 \\ 0 & 1\end{matrix} ] \frac{1}{\sqrt{2}} [ \begin{matrix}1 & 1 \\ 1 & 1 \\ 1 & - 1 \\ 1 & - 1\end{matrix} ] ,$$

$$\frac{1}{2 \sqrt{2}} [ \begin{matrix}1 & 1 \\ 1 & 1 \\ j & - j \\ j & - j\end{matrix} ] , \frac{1}{2 \sqrt{2}} [ \begin{matrix}1 & 1 \\ j & j \\ 1 & - 1 \\ j & - j\end{matrix} ] , \frac{1}{2 \sqrt{2}} [ \begin{matrix}1 & 1 \\ j & j \\ j & - j \\ - 1 & 1\end{matrix} ] , \frac{1}{2 \sqrt{2}} [ \begin{matrix}1 & 1 \\ - 1 & - 1 \\ 1 & - 1 \\ - 1 & 1\end{matrix} ] , \frac{1}{2 \sqrt{2}} [ \begin{matrix}1 & 1 \\ - 1 & - 1 \\ j & - j \\ - j & j\end{matrix} ] ,$$

$$\frac{1}{2 \sqrt{2}} [ \begin{matrix}1 & 1 \\ - j & - j \\ 1 & - 1 \\ - j & j\end{matrix} ] , \frac{1}{2 \sqrt{2}} [ \begin{matrix}1 & 1 \\ - j & - j \\ j & - j \\ 1 & - 1\end{matrix} ] .$$

However, this scheme may not be applicable for all cases. For example, if a UE reports non-coherent capability and the number of codebook SRS resources is 2, then there will be no suitable precoder. Besides, in Release 18, CG PUSCH+CG PUSCH transmission (that is configured grant PUSCH and configured grant PUSCH can be transmitted from different panels simultaneously and overlapped in time domain) and CG PUSCH+DG PUSCH transmission (that is configured grant PUSCH and dynamic scheduled PUSCH can be transmitted from different panels simultaneously and overlapped in time domain) are both supported. For Type 1 CG PUSCH, the precoder is configured by RRC and the precoder cannot be changed dynamically to ensue the number of PTRS ports is 1 if a DG PUSCH is overlapped with a CG PUSCH. That is, If the precoder of a type 1 CG PUSCH has two PTRS ports, then the CG PUSCH may not be transmitted with other PUSCH simultaneously. In these cases, the first and second schemes are preferred to avoid the reduction of gNB's flexibility.

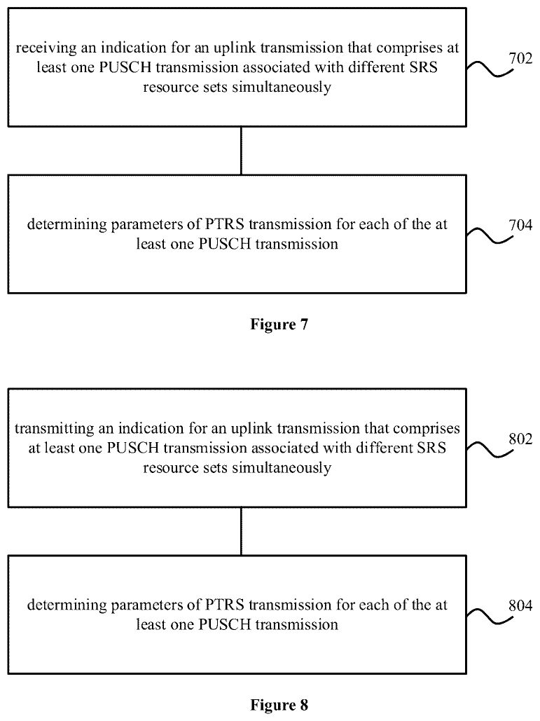

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions.

At 702, the method may include receiving an indication for an uplink transmission that comprises at least one PUSCH transmission associated with different SRS resource sets simultaneously. The operations of 702 may be performed in accordance with examples as described herein. In some implementations, aspects of the operations of 702 may be performed by a UE as described with reference to FIG. 2.

At 704, the method may include determining parameters of PTRS transmission for each of the at least one PUSCH transmission. The operations of 704 may be performed in accordance with examples as described herein. In some implementations, aspects of the operations of 704 may be performed by a UE as described with reference to FIG. 2.

It should be noted that the method described herein describes a possible implementation, and that the operations and the steps may be rearranged or otherwise modified and that other implementations are possible.

FIG. 8 illustrates a flowchart of a method in accordance with aspects of the present disclosure. The operations of the method may be implemented by a NE as described herein. In some implementations, the NE may execute a set of instructions to control the function elements of the NE to perform the described functions.

At 802, the method may include transmitting an indication for an uplink transmission that comprises at least one PUSCH transmission associated with different SRS resource sets simultaneously. The operations of 802 may be performed in accordance with examples as described herein. In some implementations, aspects of the operations of 802 may be performed by a NE as described with reference to FIG. 4.

At 804, the method may include determining parameters of PTRS transmission for each of the at least one PUSCH transmission. The operations of 804 may be performed in accordance with examples as described herein. In some implementations, aspects of the operations of 804 may be performed by a NE as described with reference to FIG. 4.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1-20. (canceled)

21. A user equipment (UE) for wireless communication, comprising:
at least one memory; and
at least one processor coupled with the at least one memory and operable to cause the UE to:
receive a higher layer parameter multipanelScheme being set to ‘SDMscheme’ for a physical uplink shared channel (PUSCH) transmission associated with different sounding reference signal (SRS) resource sets to be transmitted simultaneously; and
determine, for at least one PUSCH transmission, a PUSCH to phase tracking reference signal (PTRS) power ratio per layer per resource element (RE)
$${α}_{PTRS}^{PUSCH}$$
of a PTRS port.

22. The UE of claim 21, wherein when a higher layer parameter ptrs-Power is configured as ‘00’, the power ratio
$${α}_{PTRS}^{PUSCH}$$
of a PTRS port is 3*Qₚ−3 dB when a number of PUSCH layers associated with a same SRS resource set as the PTRS port comprises one, wherein Qₚ comprises a number of scheduled PTRS ports.

23. The UE of claim 21, wherein when a higher layer parameter ptrs-Power is configured as ‘00’, the power ratio
$${α}_{PTRS}^{PUSCH}$$
of a PTRS port is 3*Qₚ dB for full coherent codebook based PUSCH when a number of PUSCH layers associated with a same SRS resource set as the PTRS port is two, wherein Qₚ comprises a number of scheduled PTRS ports.

24. The UE of claim 21, wherein when a higher layer parameter ptrs-Power is configured as ‘00’, the power ratio
$${α}_{PTRS}^{PUSCH}$$
of a PTRS port is 3*Qₚ−3 dB for partial-coherent and non-coherent codebook based PUSCH and for non-codebook based PUSCH when a number of PUSCH layers associated with a same SRS resource set as the PTRS port is two, wherein Qₚ comprises a number of scheduled PTRS ports.

25. The UE of claim 21, wherein when a higher layer parameter ptrs-Power is configured as ‘01’, the power ratio
$${α}_{PTRS}^{PUSCH}$$
of a PTRS port is 3*Qₚ−3 dB when a number of PUSCH layers associated with a same SRS resource set as the PTRS port is one, wherein Qₚ comprises a number of scheduled PTRS ports.

26. The UE of claim 21, wherein when a higher layer parameter ptrs-Power is configured as ‘01’, the power ratio
$${α}_{PTRS}^{PUSCH}$$
of a PTRS port is 3*Qₚ dB when a number of PUSCH layers associated with a same SRS resource set as the PTRS port is two, wherein Qₚ comprises a number of scheduled PTRS ports.

27. A method performed by a user equipment (UE), the method comprising:
receiving a higher layer parameter multipanelScheme being set to ‘SDMscheme’ for a physical uplink shared channel (PUSCH) transmission associated with different sounding reference signal (SRS) resource sets to be transmitted simultaneously; and
determining, for at least one PUSCH transmission, a PUSCH to phase tracking reference signal (PTRS) power ratio per layer per resource element (RE)
$${α}_{PTRS}^{PUSCH}$$
of a PTRS port.

28. The method of claim 27, wherein when a higher layer parameter ptrs-Power is configured as ‘00’, the power ratio
$${α}_{PTRS}^{PUSCH}$$
of a PTRS port is 3*Qₚ−3 dB when a number of PUSCH layers associated with a same SRS resource set as the PTRS port comprises one, wherein Qₚ comprises a number of scheduled PTRS ports.

29. The method of claim 27, wherein when a higher layer parameter ptrs-Power is configured as ‘00’, the power ratio
$${α}_{PTRS}^{PUSCH}$$
of a PTRS port is 3*Qₚ dB for full coherent codebook based PUSCH when a number of PUSCH layers associated with a same SRS resource set as the PTRS port is two, wherein Qₚ comprises a number of scheduled PTRS ports.

30. The method of claim 27 wherein when a higher layer parameter ptrs-Power is configured as ‘00’, the power ratio
$${α}_{PTRS}^{PUSCH}$$
of a PTRS port is 3*Q−3 dB for partial-coherent and non-coherent codebook based PUSCH and for non-codebook based PUSCH when a number of PUSCH layers associated with a same SRS resource set as the PTRS port is two, wherein Qₚ comprises a number of scheduled PTRS ports.

31. The method of claim 27 wherein when a higher layer parameter ptrs-Power is configured as ‘01’, the power ratio
$${α}_{PTRS}^{PUSCH}$$
of a PTRS port is 3*Qₚ−3 dB when a number of PUSCH layers associated with a same SRS resource set as the PTRS port is one, wherein Qₚ comprises a number of scheduled PTRS ports.

32. The method of claim 27, wherein when a higher layer parameter ptrs-Power is configured as ‘01’, the power ratio
$${α}_{PTRS}^{PUSCH}$$
of a PTRS port is 3*Qₚ dB when a number of PUSCH layers associated with a same SRS resource set as the PTRS port is two, wherein Qₚ comprises a number of scheduled PTRS ports.

33. A processor for wireless communication, comprising:
at least one controller operable to cause the processor to:
receive a higher layer parameter multipanelScheme being set to ‘SDMscheme’ for a physical uplink shared channel (PUSCH) transmission associated with different sounding reference signal (SRS) resource sets to be transmitted simultaneously; and
determine, for at least one PUSCH transmission, a PUSCH to phase tracking reference signal (PTRS) power ratio per layer per resource element (RE)
$${α}_{PTRS}^{PUSCH}$$
of a PTRS port.

34. The processor of claim 33, wherein when a higher layer parameter ptrs-Power is configured as ‘00’, the power ratio
$${α}_{PTRS}^{PUSCH}$$
of a PTRS port is 3*Qₚ−3 dB when a number of PUSCH layers associated with a same SRS resource set as the PTRS port comprises one, wherein Qₚ comprises a number of scheduled PTRS ports.

35. The processor of claim 33, wherein when a higher layer parameter ptrs-Power is configured as ‘00’, the power ratio
$${α}_{PTRS}^{PUSCH}$$
of a PTRS port is 3*Qₚ dB for full coherent codebook based PUSCH when a number of PUSCH layers associated with a same SRS resource set as the PTRS port is two, wherein Qₚ comprises a number of scheduled PTRS ports.

36. The processor of claim 33, wherein when a higher layer parameter ptrs-Power is configured as ‘00’, the power ratio
$${α}_{PTRS}^{PUSCH}$$
of a PTRS port is 3*Qₚ−3 dB for partial-coherent and non-coherent codebook based PUSCH and for non-codebook based PUSCH when a number of PUSCH layers associated with a same SRS resource set as the PTRS port is two, wherein Qₚ comprises a number of scheduled PTRS ports.

37. The processor of claim 33, wherein when a higher layer parameter ptrs-Power is configured as ‘01’, the power ratio
$${α}_{PTRS}^{PUSCH}$$
of a PTRS port is 3*Qₚ−3 dB when a number of PUSCH layers associated with a same SRS resource set as the PTRS port is one, wherein Qₚ comprises a number of scheduled PTRS ports.

38. The processor of claim 33, wherein when a higher layer parameter ptrs-Power is configured as ‘01’, the power ratio
$${α}_{PTRS}^{PUSCH}$$
of a PTRS port is 3*Qₚ dB when a number of PUSCH layers associated with a same SRS resource set as the PTRS port is two, wherein Qₚ comprises a number of scheduled PTRS ports.

39. A user equipment (UE) for wireless communication, comprising:
at least one memory; and
at least one processor coupled with the at least one memory and operable to cause the UE to:
receive an indication for an uplink transmission that comprises at least one physical uplink shared channel (PUSCH) transmission associated with different sounding reference signal (SRS) resource sets to be transmitted simultaneously; and
determine parameters of phase tracking reference signal (PTRS) transmission for the at least one PUSCH transmission.

40. The UE of claim 39, wherein:
the indication is that a higher layer parameter multipanelScheme is configured and set to ‘SDMscheme’;
the uplink transmission is one PUSCH transmission with different layers of the PUSCH transmission associated with different SRS resource sets; and
the parameters comprise PUSCH to PTRS power ratio per layer per resource element (RE),
$${α}_{PTRS}^{PUSCH}$$
of a PTRS port.
